(19) United States
(12) Patent Application Publication
(10) Pub. No.: US 2023/0030195 A1
(43) Pub. Date: Feb. 2, 2023

(54) WIRELESS TRANSMISSION OF A PER-STATION PROFILE AND APPARATUS FOR TRANSMISSION

(71) Applicant: NXP USA, Inc., AUSTIN, TX (US)

(72) Inventors: Liwen Chu, San Ramon, CA (US); Hongyuan Zhang, Fremont, CA (US); Huiling Lou, Sunnyvale, CA (US)

(21) Appl. No.: 17/815,741

(22) Filed: Jul. 28, 2022

Related U.S. Application Data
(60) Provisional application No. 63/226,346, filed on Jul. 28, 2021.
(60) Provisional application No. 63/234,236, filed on Aug. 17, 2021.

(51) Int. Cl. H04W 76/15; H04L 5/00

(52) U.S. Cl. CPC H04W 76/15; H04L 5/0044; H04W 84/12

(57) ABSTRACT

A management frame is generated which comprises a per-station profile of an access point (AP) affiliated with a AP multilink device (MLD) having a non-transmitted basic service set identifier (BSSID) AP. The per-station profile is carried in two or more elements, each element comprising an element identifier, a length, and an information field which carries a respective fragment of the per-station profile and the two or more elements are not in a multiple BSSID element. The management frame is transmitted to a station, wherein a non-AP of the station associates with the AP MLD based on the management frame.

### RELATED APPLICATION

This application claims a benefit of priority to U.S. Provisional Application No. 63/234,236, entitled “Element Fragmentation” filed Aug. 17, 2021 and U.S. Provisional Application No. 63/226,346, entitled “Element Fragmentation” filed Jul. 28, 2021, the contents each of which are incorporated herein by reference in its entirety.

### FIELD OF USE

This disclosure generally relates to wireless communication, and more particularly to wireless transmission of a per-station profile, and apparatus for transmission.

### BACKGROUND

In multilink communications associated with IEEE 802.1be and other WiFi standards, an access point (AP) of an AP multilink device (MLD) wirelessly transmits data to a station of a non-AP MLD via a wireless communications link. To facilitate proper data transmission within a multilink communications system, information related to the AP is transmitted to the station during a discovery period or setup period which includes a per-station profile which carries capabilities, parameters and operational data of the AP.

### BRIEF DESCRIPTION OF THE DRAWINGS

FIG. 1 depicts a multilink communications system in accordance with an embodiment of the invention.

FIG. 2 depicts an example per-station profile element having a per-station profile that is transmitted by the multilink communication system in accordance with an embodiment.

FIG. 3 depicts an example probe response which carries the per-station profile element in accordance with an embodiment.

FIG. 4 depicts an example fragmentation of a per-station profile associated with a per-station profile element in accordance with an embodiment.

FIG. 5 depicts an example multilink element having a per-station profile that is transmitted by the multilink communication system in accordance with an embodiment.

FIG. 6 depicts an example fragmentation associated with the per-station profile of the multilink element in accordance with an embodiment.

FIG. 7 depicts an example Action frame which carries the multilink element having the per-station profile in accordance with an embodiment.

FIG. 8 depicts a flow chart of functions associated with generating and transmitting the per-station profile from an AP of an AP multilink device (MLD) to a station of a non-AP MLD in accordance with an embodiment.

The drawings are for the purpose of illustrating example embodiments, but it is understood that the embodiments are not limited to the arrangements and instrumentality shown in the drawings.

### DETAILED DESCRIPTION

The description that follows includes example systems, methods, techniques, and program flows associated with wireless transmission and fragmentation of an element or subelement having a per-station profile.

### Overview

An AP multilink device (MLD) comprises one or more access points (AP) and a non-AP MLD comprises one or more stations. Each AP and its corresponding associated station are further coupled by a communication link. In the IEEE 802.11be standard, a transmitted basic service set identification (BSSID) access point (AP) of a multiple BSSID set associated with a communication link transmits a beacon which includes a multiple BSSID element having one or more nontransmitted BSSID profile subelements. Each subelement carries a nontransmitted BSSID profile of a nontransmitted BSSID AP in the multiple BSSID set. Further, the beacon has a multilink element which identifies common information of AP MLDs (as an element of a beacon or in a subelement of a multiple BSSID element) and a Reduced Neighbor Report (RNR) which identifies APs affiliated on different communication links with a same AP MLDs as the transmitted/nontransmitted BSSID APs. In some examples, the station of a non-AP MLD further transmits a Multilink Probe Request to the transmitted BSSID AP over the communication link to obtain a per-station profile of an AP affiliated with the same AP MLD as a nontransmitted BSSID AP, where the affiliated AP is on another communication link. The transmitted BSSID AP transmits a Multilink Probe Response with a multilink element over the communication link having the per-station profile of the AP, where the multilink element is in a nontransmitted BSSID AP profile subelement of a multiple BSSID element. After acquiring the profiles of the APs affiliated with an AP MLD, a non-AP MLD uses one Association Request frame to associate with the AP MLD with which the nontransmitted BSSID AP is affiliated.

The per-station profile in the Multilink Probe Response is typically a small amount of data because the per-station profile of a reported AP is based on an inheritance of certain information in the per-station profile of the transmitted BSSID AP and/or the nontransmitted BSSID profile of the nontransmitted BSSID AP. But in scenarios where the per-station profile of the transmitted BSSID AP and the nontransmitted BSSID profile has information that is different from the reported AP, one or more of the multiple BSSID element, the nontransmitted BSSID profile subelement, or the multilink element which carry a per-station profile could exceed a maximum size limit such as 255 octets defined by the baseline IEEE 802.11 standard. This requires a fragmentation procedure to deal with fragmentation of a per-STA profile subelement in a fragment of a multilink element (since multilink element is also more than 255 octets) where the fragment of the multilink element is in a fragment of a nontransmitted BSSID profile subelement of Multiple BSSID element. The fragmentation of multiple-level embedded subelement/element increases complexity of transmitting the per-station profile in the Multilink Probe Response.

Embodiments disclosed herein are directed to reducing complexity of transmitting a per-station profile of an AP affiliated with the same AP MLD as a nontransmitted BSSID AP. In one example, a transmitted BSSID AP receives a Multilink Probe Request and transmits a Multilink Probe Response in response to the Multilink Probe Request having a per-station profile element with a per-station profile of the AP affiliated with the nontransmitted BSSID AP of the AP MLD and a station info field of the per-station profile element having an indication of the AP MLD of the AP. If a per-station profile is greater than the maximum size limit, then the per-station profile is fragmented by an 802.11 element fragmentation procedure to fragment the per-station profile element and the fragment elements are transmitted. The per-station profile element is not included in a multiple BSSID element or multilink element of the Multilink Probe Response to reduce complexity of the fragmentation. In another example, the multilink element with per-STA profile subelement is not encapsulated in a nontransmitted BSSID Profile subelement of a Multiple BSSID element in Multilink Probe Response frame, and the per-station profiles in the multilink element related to the AP MLD is indicated by the methods other than the indication by the nontransmitted BSSID profile that encapsulates the multilink element. For example, a nontransmitted BSSID AP of an AP MLD receives a Multilink Probe Request for a per-station profile of an AP affiliated with the nontransmitted BSSID AP of the same AP MLD. The nontransmitted BSSID AP transmits an Action frame (e.g., Multilink Probe Response frame) with a multilink element in response to the Multilink Probe Request, where the transmitter identifies the AP MLD of the multilink element. A subelement of the multilink element includes a per-station profile of an AP affiliated with the same AP MLD as the nontransmitted BSSID AP. A fragment subelement is defined. If the per-station profile exceeds the maximum size limit, then the per-station profile is fragmented and transmitted in the fragment element. The multilink element is not included in a nontransmitted BSSID profile of a multiple BSSID element to reduce complexity of the fragmentation and a transmitter address (TA) (address 2 in MAC header) of the Multilink Probe Response indicates the nontransmitted BSSID AP (also uniquely matching the MLD ID) related to the multilink element. The disclosed per-station profile element and per-station profile in a multilink element for an AP MLD that a nontransmitted BSSID AP is affiliated (where the multilink element is carried in an Action frame) reduces complexity associated with fragmentation of the per-station profile greater than the maximum size limit in a multilink element of a nontransmitted BSSID profile of a multiple BSSID element. Well known instructions, protocols, structures, and techniques have not been shown in detail in order not to obfuscate the description.

### Example Systems

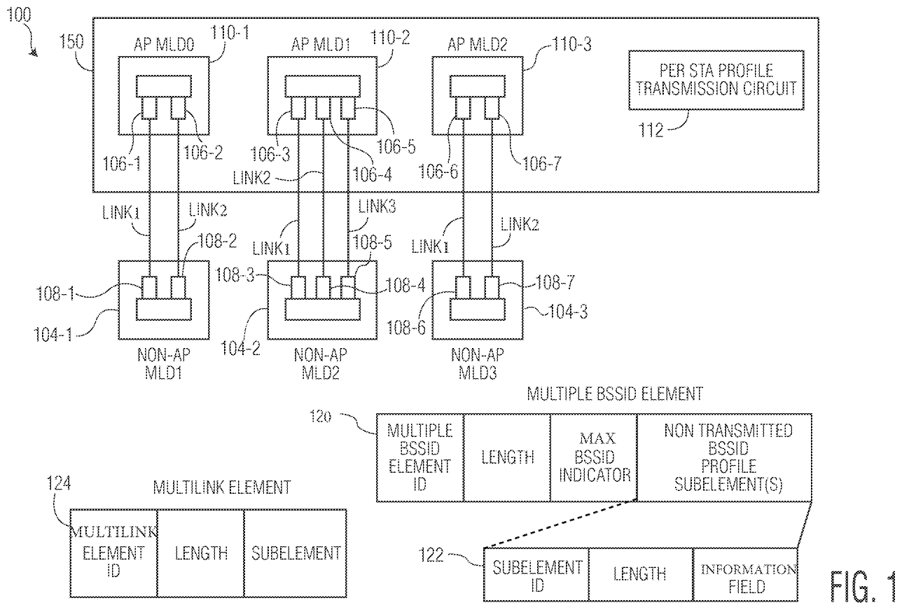

FIG. 1 depicts a multilink communications system 100 in accordance with an embodiment of the invention. The multilink communications system 100 may be used in various applications, such as industrial applications, medical applications, computer applications, and/or consumer or appliance applications. In some embodiments, the multilink communications system 100 may be compatible with an Institute of Electrical and Electronics Engineers (IEEE) 802.11 protocol such as IEEE 802.11be protocol.

The multilink communications system 100 may include one or more AP multilink device (MLD) and one or more non-AP MLD. Each AP MLD may have one or more APs and each non-AP MLD may have one or more non-APs. In the embodiment depicted in FIG. 1, the one or more AP MLD may be AP MLDs 110-1, 110-2, 110-3 and the one or more non-AP MLD may be non-AP MLDs 104-1, 104-2, 104-3. The AP MLD and non-AP MLD may be logical devices and each AP MLDs 110-1, 110-2, 110-3 and non-AP MLD may be in a respective AP physical wireless system 150 and non-AP physical wireless system (not shown). The AP MLD and the non-AP MLD may be implemented in hardware (e.g., circuits or integrated circuit), software, firmware, or a combination thereof. The AP MLD may be compatible with at least one wireless local area network (WLAN) communications protocol (e.g., at least one IEEE 802.11 protocol) such as IEEE 802.11be protocol. In some embodiments, the AP MLD connects to a local area network (e.g., a LAN) and/or to a backbone network (e.g., the Internet) through a wired connection and performs wireless communication with a non-AP MLD. The non-AP MLD may be a laptop, a desktop personal computer (PC), a mobile phone, or other wireless device that supports at least one WLAN communications protocol with the AP MLD. In some embodiment, a common part of the AP MLD or non-AP MLD implements functionalities common to its APs or stations and the APs or stations implement functionalities related to the wireless communication over a communication channel.

In some embodiments, the multilink communications system 100 may include fewer or more components to implement the same, less, or more functionality. For example, although the multilink communications system 100 shown in FIG. 1 includes the AP MLD 110-1, 110-2, 110-3 and the non-AP MLDs 104-1, 104-2, 104-3, in other embodiments, the multilink communications system 100 includes fewer or more AP MLDs and/or non-AP MLDs.

In the embodiment depicted in FIG. 1, each AP MLD includes one or more APs for creating a wireless network over one or more links. For example, AP MLD 110-1 may include APs 106-1, 106-2, the AP MLD 110-2 may include APs 106-3, 106-4, 106-5, and the AP MLD 110-3 may include APs 106-6, 106-7. Similarly, the non-AP MLD includes one or more stations coupled to a wireless network created by an AP. For example, non-AP MLD 104-1 may include stations 108-1, 108-2, the non-AP MLD 104-2 may include stations 108-3, 108-4, 108-5, and the non-AP MLD 104-3 may include stations 108-6, 108-7. The stations of the non-AP MLD may be stations which are not APs. Although the AP MLD and non-AP MLD are shown in FIG. 1 as including two or three APs and stations respectively, other embodiments may include fewer than two or three stations or more than three stations. A link may be arranged between an AP and non-AP to establish the wireless communication. For example, AP 106-1, 106-3, 106-6 may be coupled to non-AP 108-1, 108-3, 108-6 by a link 1. In another example, AP 106-2, 106-4, 106-7 may be coupled to non-AP 108-2, 108-4, 108-7 by a link 2. In yet another example, AP 106-5 may be coupled to non-AP 108-5 by a link 3. The link may be a wireless channel in a frequency spectrum for enabling wireless communications between the AP and non-AP.

In embodiments, an AP includes at least one antenna, at least one transceiver operably connected to the at least one antenna, and at least one controller operably connected to the corresponding transceiver to facilitate the wireless communication over a communication link. In some embodiments, the least one transceiver includes a physical layer (PHY) device. The at least one controller may be operably configured to control the at least one transceiver to process received packets through the at least one antenna. In some embodiments, the at least one controller is implemented within a processor, such as a microcontroller, a host processor, a host, a digital signal processor (DSP), or a central processing unit (CPU), which can be integrated in a corresponding transceiver. Each of the APs of the AP MLD may operate in a different frequency band or in different channels of a same band. For example, the AP 106-1, 106-3, 106-6 of link 1 may operate in a 2.4 Gigahertz (GHz) frequency band, the AP 106-2, 106-4, 106-7 of link 2 may operate in a 5 GHz frequency band, and the AP 106-5 of link 3 may operate in a 6 GHz frequency band. Other variations are also possible.

In embodiments, each station of a non-AP MLD also includes at least one antenna, at least one transceiver operably connected to the at least one antenna, and at least one controller connected to the corresponding transceiver to facilitate the wireless communication over a communication link. In some embodiments, the at least one transceiver includes a PHY device. The at least one controller operably may be configured to control the at least one transceiver to process received packets through the at least one antenna. In some embodiments, the at least one controller is implemented within a processor, such as a microcontroller, a host processor, a host, a DSP, or a CPU, which can be integrated in a corresponding transceiver. Each stations of the non-AP MLD may operate in a different frequency band or in different channels of the same band. For example, the station 108-1 may operate in a 2.4 gigahertz (GHz) frequency band, the station 108-4 may operate in a 5 GHz frequency band, and the AP 106-5 may operate in a 6 GHz frequency band. Other variations are also possible.

An AP and one or more stations which are associated with the AP define a Basic Service Set (BSS) and work in one link. Further, APs may support a BSS identifier (BSSID) set. The BSSID set may include a transmitted BSSID AP or non-transmitted BSSID AP on a same communication link. Typically, an AP may have a transmitted BSSID which means that the AP transmits management frames which include beacon frames or Probe Response frames to Probe Request frames or a nontransmitted BSSID AP which means that the AP does not transmit Beacon frames or Probe Response frames to Probe Request frames.

In the multilink communications system 100, the AP 106-1 may be a transmitted BSSID AP (AP with transmitted BSSID) and the AP 106-3, 106-6 may be nontransmitted BSSID APs (APs with transmitted BSSIDs) for link 1 as an example. In the baseline IEEE 802.11be standard, a transmitted BSSID AP of a multiple BSSID set on a link transmits a beacon with one or more elements to the stations on the link. The beacon on a link may be periodically transmitted by the transmitted BSSID AP affiliated with an AP MLD to advertise one or more nontransmitted BSSID profiles of non-transmitted BSSID APs affiliated with AP MLDs of the multilink communication system 100. Further, the beacon has a multilink element 124 which identifies common information of AP MLDs (as an element of a beacon or in a subelement of a multiple BSSID element) and a Reduced Neighbor Report (RNR) which identifies APs affiliated on different communication links with a same AP MLDs as the transmitted/nontransmitted BSSID APs.

The element may be a data structure for carrying information of an AP and includes an element identifier field, a length field, and an information field. The element identifier field may indicate a type of the element, the length field may indicate a length of the element, and the information field may carry information of the element. The elements of the beacon of a transmitted BSSID AP affiliated with an AP MLD may typically be a multiple BSSID element 120 and the multilink element 124. The transmitted BSSID AP transmits the multiple BSSID element 120 defined by the IEEE 802.11 baseline standard and revised by IEEE 802.11be standard to advertise information for nontransmitted BSSID AP of a BSSID set using a single management frame (such as a. Beacon frame or Probe Response frame) instead of using multiple Beacon or Probe Response frames. The transmission of the multiple BSSID element has the advantage of reducing network overhead.

The multiple BSSID element 120 may have one or more nontransmitted BSSID AP profile subelements which carry a respective information of a nontransmitted BSSID AP in the multiple BSSID set. The subelement 122 is shown as having a subelement identifier field which identifies the element as a subelement, a length field, and an information field which would carry the per-station profile of a non-transmitted BSSID AP. As an example, the transmitted BSSID 110-1 may transmit a beacon with the multiple BSSID element 120 having one or more nontransmitted BSSID profile subelements with nontransmitted BSSID profile of the nontransmitted BSSID AP 106-3 of AP MLD 110-2 and the nontransmitted BSSID AP 106-6 of AP MLD 110-3 in the multiple BSSID set for link 1. Further, the beacon has a multilink element 124 which identifies common information of AP MLDs (as an element of a beacon or in a subelement of a multiple BSSID element) and a Reduced Neighbor Report (RNR) which identifies APs affiliated on different communication links with a same AP MLDs as the transmitted/nontransmitted BSSID APs. In an example, the multilink element 124 and RNR may identify that AP 106-2 is affiliated with the transmitted BSSID AP 106-1, AP 106-4, AP 106-5 is affiliated with the nontransmitted BSSID AP 106-3, and AP 106-7 is affiliated with the nontransmitted BSSID AP 106-6. The affiliated APs might support the Multiple BSSID feature in which case the information of the reported APs affiliated with the same AP MLD as the nontransmitted BSSID AP and affiliated with the same AP MLD as the transmitted BSSID AP may be transmitted by the transmitted BSSID. In other examples, the affiliated APs might not support the Multiple BSSID Feature in which case information of the reported APs affiliated with the same AP MLD as an AP is transmitted by the AP.

A non-AP MLD may use the information which is received in the beacon to associate with the AP MLD that includes as an affiliated AP the AP that transmits the beacon. The association process is a process of establishing a wireless connection between the AP MLD and the non-AP MLD to transfer data. If a non-AP MLD seeks to associate with another AP MLD with multiple affiliated APs, the non AP MLD transmits a Multilink Probe Request to the transmitted BSSID AP (or the AP that transmits the beacon if the AP does not support a multiple BSSID feature) to request the per-station profile of an AP on the different link affiliated with the other AP MLD. If the requested information is about an AP in another link affiliated with the other AP MLD having a nontransmitted BSSID AP, the transmitted BSSID AP transmits a Multilink Probe Response with a multiple BSSID element having the nontransmitted BSSID profile sublement of the nontransmitted BSSID AP which includes a multilink element 124. The multilink element 124 will carry the per-station profile of the APs affiliated with the non-transmitted BSSID AP on the different links as subelements. The multilink element 124 may have a per-station profile of an AP affiliated with the same AP MLD as the transmitted BSSID AP, or a per-station profile of an AP affiliated with the same AP MLD as the non-transmitted BSSID AP. The per-station profile may define capabilities, parameters and operational data of an AP. As an example operation, a Multilink Probe Request may be sent from the station 108-3 to the transmitted BSSID AP 106-1 which indicates a request for information of an AP 106-4 (reported AP) and a Multilink Probe Response is sent from the transmitted BSSID AP 106-1 to the station 108-3 which indicates the information of the AP 106-4. The information in the per-station profile defining capabilities, parameters and operational data of the AP 106-4 enables the non-AP MLD 104-2 to establish an association with the AP MLD 110-2.

The per-station profile of the reported AP carried in the nontransmitted BSSID profile subelement of the nontransmitted BSSID AP in the multiple BSSID element 120 typically defines a small amount of data because a per-station profile of a reported AP inherits certain information from the nontransmitted BSSID profile and inherits certain information from the information of the transmitted BSSID AP. But in scenarios where the nontransmitted BSSID profile has information that is different from the per-station profile of a reported AP affiliated with the same AP MLD as a nontransmitted BSSID AP or the information of the transmitted BSSID AP, the per-station profile of the reported AP affiliated with the same AP MLD as the nontransmitted BSSID AP may exceed a maximum subelement size such as 255 octets. The baseline 802.11 standard specifies a fragmentation process where the nontransmitted BSSID profile is fragmented across multiple nontransmitted BSSID Profile subelements that are carried across multiple multiple BSSID elements. But there is no similar simple process for fragmentation defined by the baseline 802.11 standard or 801.11 11be standard when a per-station profile of a reported AP affiliated with same AP MLD as a nontranmitted BSSID AP carried in a multilink element which is then carried in nontransmitted BSSID profile subelement in the multiple BSSID element exceeds a maximum size limit such as 255 octets. A complex fragmentation is required for such information exchange.

Embodiments disclosed herein are directed to reducing the complexity of transmitting a per-station profile of an AP affiliated with the same AP MLD as a nontransmitted BSSID AP. In one example, a transmitted BSSID AP transmits a Multilink Probe Response after receiving a Multilink Probe Request received from a station affiliated with an non-AP MLD which requests a per-station profile of an AP affiliated with the same AP MLD as a nontransmitted BSSID AP. The AP system 150 may have a per-station profile transmission circuit 112 which is a processing circuit to generate the Multilink Probe Response which include a per-station profile element having a per-station profile of the AP affiliated with the same AP MLD as the nontransmitted BSSID AP and a station info field of the per-station profile element having an indication of the AP MLD. A fragment subelement is defined. If a per-station profile is greater than the maximum size limit, then the per-station profile transmission circuit 112 may fragment the per-station profile. The per-station profile element with the per-station profile is not included in a multilink element of the nontransmitted BSSID profile of a multiple BSSID element or multilink element in the Multilink Probe Response to reduce complexity of the fragmentation of the per-station profile. In another example, the multilink element with per-STA profile subelement is not encapsulated in a nontransmitted BSSID Profile subelement of a Multiple BSSID element in a Multilink Probe Response frame, and the per-station profiles in the multilink element related to the AP MLD is indicated by the methods other than the indication by the nontransmitted BSSID profile that encapsulates the Multilink element. For example, a nontransmitted BSSID AP of an AP MLD receives a Multilink Probe Request for a per-station profile of an AP affiliated with the nontransmitted BSSID AP of the AP MLD. The per-station profile transmission circuit 112 may cause the nontransmitted BSSID AP to transmit an Action frame (e.g., Multilink Probe Response Frame) with a multilink element in response to the Multilink Probe Request where the transmitter identifies the AP MLD of the Multilink element. A subelement of the multilink element includes a per-station profile of the requested AP affiliated with the same AP MLD as the nontransmitted BSSID AP. If the per-station profile exceeds the maximum size limit, then the per-station profile transmission circuit 112 may fragment the per-station profile. The disclosed per-station profile element and per-station profile in a multilink element of an Action frame where the multilink element is for an AP MLD that a nontransmitted BSSID AP is affiliated reduces complexity associated with fragmentation of the per-station profile greater than the maximum size limit in a multilink element of a nontransmitted BSSID profile of a multiple BSSID element.

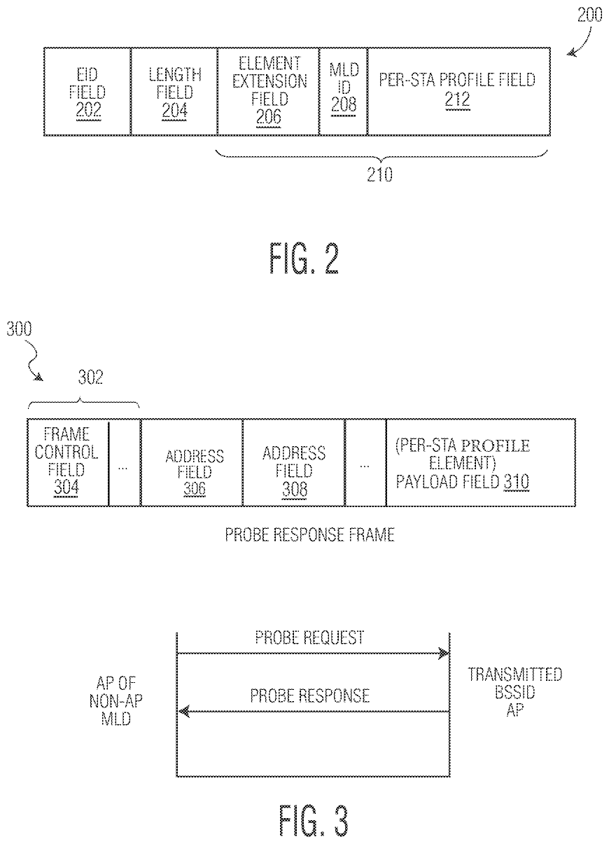

FIG. 2 depicts an example per-station profile element 200 having a per-station profile that is transmitted by the multilink communication system 100 in accordance with an embodiment. The per-station profile element 200 may have a plurality of fields including an element identification (EID) field 202, a length field 204, and an information field 210. The per-station profile element 200 may be identified by the element identification field 202 and element identifier extension field 206 in the information field 210. In an example, a value of the element identification field 202 which is one octet may indicate that the element identifier extension field 206 is present and the element identifier extension field 206 which is also one octet may indicate that the element 200 is a per-station profile element. The length field 204 may indicate a number of octets in the information field 210 which typically ranges from 1 to 255 octets. In addition to the element identifier extension field 206, the information field 210 may have a plurality of fields such as a station control field (not shown), a station information field 208 (shown), and a per-station profile field 212 which is a variable length from 0 to 254 octets. In an example, the per-station profile field 212 may carry a per-station profile and define capabilities, parameters and operational data of an AP. The AP MLD may be identified in the station information field 208 such as AP MLD 0, AP MLD 1, or AP MLD 2. In some embodiments, the MLD identification in the station information field 208 of the per-station profile element may be an index in a multiple BSSID index element which identifies the AP MLD. The multiple BSSID index element may be in a nontransmitted BSSID profile subelement associated with the nontransmitted BSSID AP having the nontransmitted BSSID profile of the nontransmitted BSSID AP. Further, the per-station profile element with the per-station profile is not included in a multilink element of a nontransmitted BSSID profile of a multiple BSSID element or multilink element of the Multilink Probe Response to reduce complexity of the fragmentation of the per-station profile.

FIG. 3 depicts an example Multilink Probe Response 300 which carries the per-station profile element 200 in accordance with an embodiment. The Multilink Probe Response may be transmitted by a transmitted BSSID AP to a station of a non-AP MLD in response to a Multilink Probe Request from the station. The Multilink Probe Response frame 300 may include a management header 302 with one or more fields such as a frame control field 304 indicating that the frame is a Multilink Probe Response and a duration/Association ID field (not shown), along with one or more address fields 306, 308 which may indicate a source address and a destination address of the Multilink Probe Response 300. The source address field 308 may identify a source of the Multilink Probe Response 300 which could include an identification of the transmitted BSSID AP which transmits the probe response and its AP MLD. The destination address field 306 may indicate a destination address of the Multilink Probe Response such as a station of an non-AP MLD in the multilink communication system 100. The Multilink Probe Response 300 may also have a payload field 310. The payload field 310 may include response data to the Multilink Probe Request which in an example is the per-station profile element that is transmitted.

In some examples, the per-station profile of a nontransmitted BSSID AP may be greater than a maximum length such as 254 octets. The per-station profile transmission circuit 112 may generate a fragment element to carry a portion of the per-station profile in accordance with a fragmentation process. Because the per-station profile is not carried in a multiple BSSID element, complexity associated with fragmentation of the per-station profile is lessened.

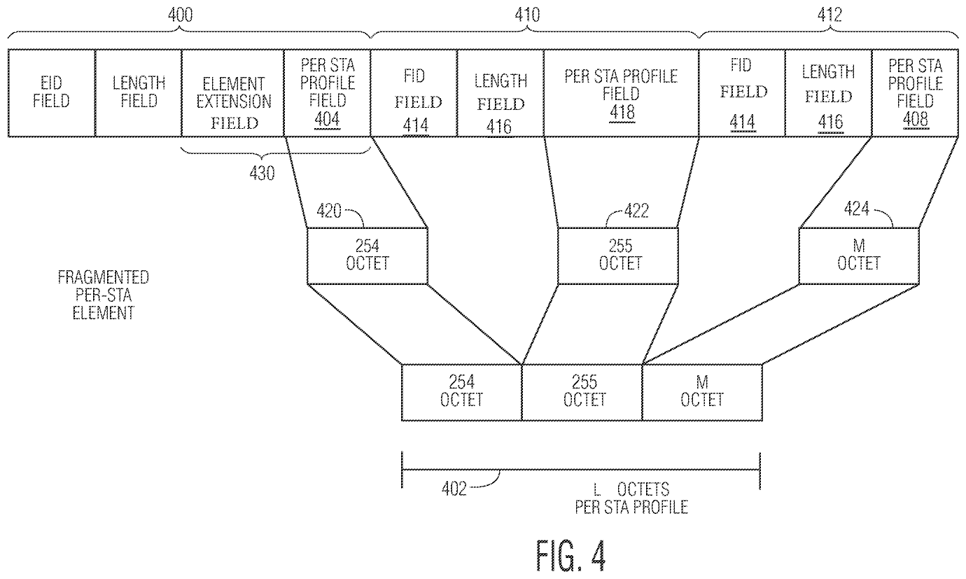

FIG. 4 depicts an example fragmentation of a per-station profile 402 associated with a per-station profile element 400 in accordance with an embodiment. The per-station profile 402 may have a length L octets which is greater than a maximum length such as 254 octets (255-1 octet for element extension field) that is able to be carried in the information field 430 of the per-station profile element 400. A fragment of the per-station profile 420 which is 254 octets may be carried by the per-station profile element 400 which has an element identifier field, a length field, and the information field 430 with an element extension field which indicates that it is a per-station profile element and the per-station profile field 404. Additional fragments of the per-station profile which is up to 255 octets may be carried as one or more fragment elements. A fragment element includes a fragment identifier field 414, a length field 416, and a per-station profile field 418. In an example, the fragment identifier field 414 and the length field 416 may be one octet and the per-station profile field 418 which carries a fragment of a per-station profile may be a variable size ranging from 0 to 255 octets. In the example, the per-station profile 402 is divided into three fragments where a first fragment 420 may be carried in the per-station profile element 400 and has a length of 254 octets. A second fragment 422 which has a length of 255 octets may be carried in the fragment element 410 and a third fragment 424 which has a length of M octets may be carried in the fragment element 412. In other examples, fewer fragment elements or more fragment elements may carry fragments of the per-station profile depending on a number of fragments of the per-station profile.

In some examples, a station of a non-AP MLD may transmit a Multilink Probe Request to a nontransmitted BSSID AP of an AP MLD on a link to request a per-station profile of an AP affiliated with the nontransmitted BSSID AP of the same AP MLD rather than transmitting the Probe Request to the transmitted BSSID AP. In response to the Probe Request, the nontransmitted BSSID AP on the link may transmit a management frame in the form of an Action frame of IEEE 802.11be with a multilink element having a per-station profile of one or more APs in a same AP MLD as the nontransmitted BSSID AP. The non-AP MLD of the station may use the received per-station profile to associate with the AP MLD having the nontransmitted BSSID AP. The nontransmitted BSSID AP may not transmit the multilink element with the per-station profile in a multiple BSSID element to reduce complexity associated with fragmentation of the per-station profile.

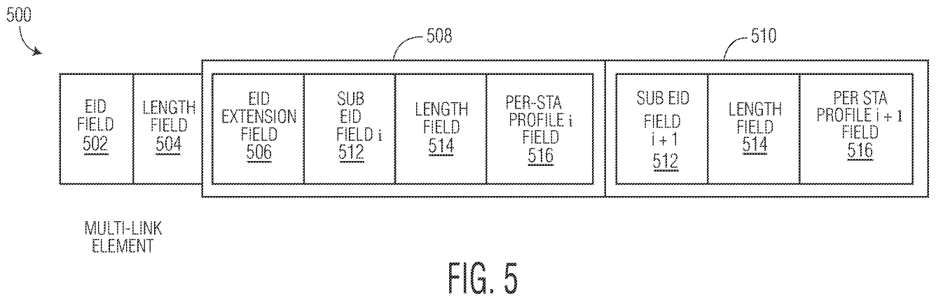

FIG. 5 depicts an example multilink element 500 having a per-station profile that is transmitted by the multilink communication system 100 in accordance with an embodiment. The multilink element 500 includes an element identifier field 502 (e.g., 1 octet), a length field 504 (e.g., 1 octet) that may contain element length information, and one or more subelements to carry information of an MLD, e.g., an information field. The multilink element 500 may have one or more subelements shown as subelement 508, 510 in this example. The element identifier field 502 and the element identifier extension field 506 (e.g., 1 octet) which is in a subelement 508 may contain identification information that indicates that the element is a multilink element 500. The subelement 508 as an example may further include a subelement identifier field 512, a length field 514, and a per-station profile field 516. The subelement identifier field (EID) 512 may indicate a type of the subelement which is a per-station profile, the length field may indicate a length of the data in the per-station profile field 516. The per-station profile field 516 may comprise a per-station profile i where i is an integer which corresponds to a particular AP. In an example the length field 514 may be one octet and the per-station profile field 508 may store up to 252 octets (255-3 octets relating to fields 506, 512, 514) when a subelement includes up to 255 octets. The subelement 510 may have similar fields. A nontransmitted BSSID AP may receive from a station of an non-AP MLD on a link such as link 1 a Probe Request for a respective per-station profile of one or more nontransmitted BSSID AP of an AP MLD. The nontransmitted BSSID AP of the AP MLD may receive this Probe Response and transmit an Action frame on the link 1 to the station with the multilink element carrying the per-station profile of the one or more nontransmitted BSSID AP of the AP MLD. In an example, the station 108-3 may transmit the Probe Request over link 1 to the nontransmitted BSSID AP 106-3. The non-transmitted BSSID AP 106-3 may transmit the Action frame which comprises a multilink element with the per-station profile for AP 106-4 on link 2 and AP 106-5 on link 3 in an example as subelements of the multilink element. Based on the Action frame, the non-AP MLD 104-2 with the station 108-3 may establish an association with the AP MLD 110-2.

In some examples, the per-station profile of an AP affiliated with the non-transmitted BSSID AP in the AP MLD may be greater than a maximum length of the per-station profile field of the multilink element such as 252 octets and not able to be carried in the subelement 508 of the multilink element 500. The per-station profile may be fragmented in accordance with a fragmentation process associated with the multilink element.

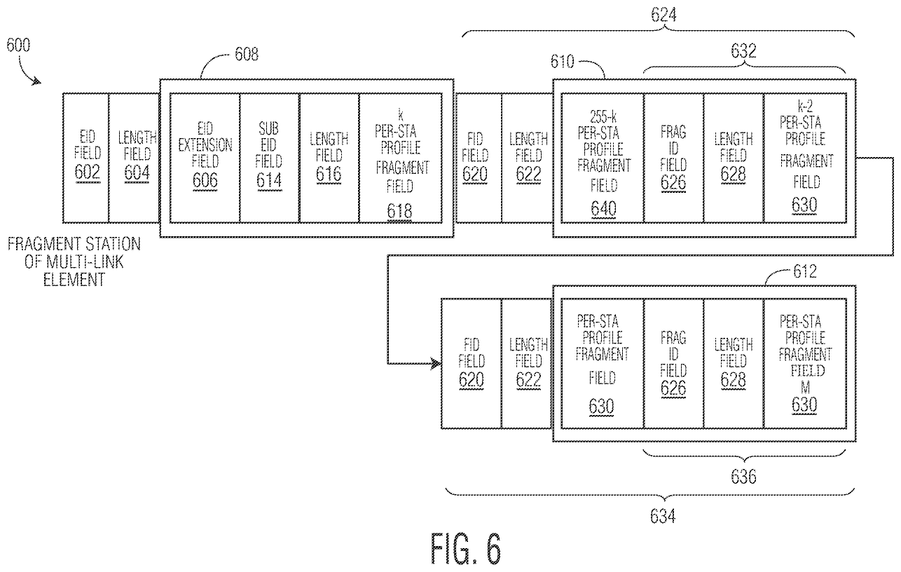

FIG. 6 depicts an example fragmentation associated with the per-station profile of the multilink element 500 in accordance with an embodiment. The per-station profile may be fragmented when it is greater than 254 octets and subdivided into one or more fragments.

A multilink element 600 may have an element identification field 602, a length field, and one or more subelements. The subelement 608 may have an element extension field 606, a subelement identifier field 614 and a length field 616 of the subelement 608. The per-station profile fragment field 618 of the subelement 608 may include a fragment of the per-station profile which is k=maximum length-3 or 252 octets where the maximum length is a maximum length of the subelement of the multilink element, e.g., 255 octets. A fragment element 624 may carry another fragment of the per-station profile. The fragment element 624 may have a fragment identifier (FID) field 620 which indicates the fragment element followed by a length field 622 which indicates a length of an information field 610 of the fragment element 624. The information field 610 of the fragment element 624 may have a per-station profile fragment field field 640 which has a fragment of per-station profile such that a total length of the fragment in both the per-station profile fragment field 618 and the per-station profile fragment field 640 is a maximum length of 255 octets. Further, the fragment element 624 may define a fragment subelement 632 to carry yet another fragment of the per-station profile. The fragment subelement 632 may have a fragment identification field 626 which indicates a fragment subelement and a length field 628 which indicates a length of the fragment subelement 632. The fragment subelement 632 may also include a per-station profile fragment field 630 which carries a fragment of the per-station profile such that a length of the fragments in the per-station profile fragment field 640 and 630 is a maximum length of 253 octets. If the per-station profile still is not able to be carried by the fragment element 624, the multilink element 600 may include another fragment element 634. The fragment element 634 may have a fragment identifier field 620, a length field 622, and an information field 612. The information field 612 may carry a fragment of a per-station profile in a manner similar to that described above followed by another fragment subelement 636 which carries a fragment of the per-station profile. The process may be repeated to generate the multilink element 600. An AP with nontransmitted BSSID AP may transmit an Action frame with the multilink element. Further, the multilink element may not be in a Multiple BSSID element.

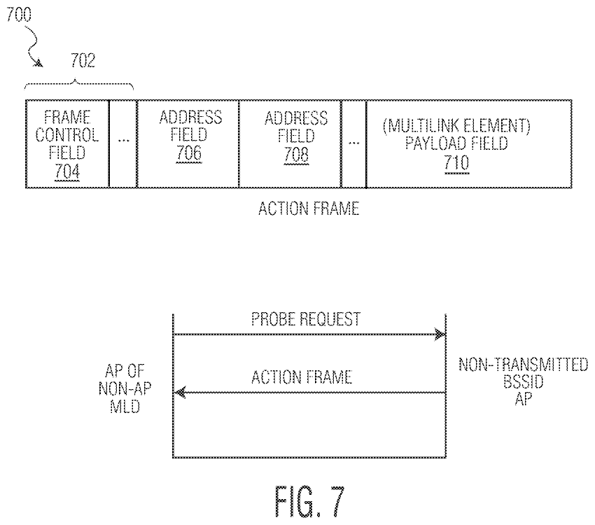

FIG. 7 depicts an example Action frame 700 which carries the multilink element having the per-station profile in accordance with an embodiment. The Action frame may be transmitted by a non-transmitted BSSID AP to a station of a non-AP MLD in response to a Probe Request from the station. The Action frame 700 may include a management header 702 having a frame control field 704 indicating that the frame is an Action frame, one or more address fields 706, 708 which may define a source address of the Action frame 700, and a destination address of the Action frame 700. The source address may identify a source of the Action frame 700 which could include an identification of the nontransmitted BSSID AP which transmits the Action frame 700 and an indication of its AP MLD. The destination address field may indicate a destination address of the Action frame such as a station in the multilink communication system 100. The Action frame 700 may also have a payload field 710. The payload field 710 may include response data to the Probe Request which in an example is the multilink element that is transmitted. Because the Action frame 700 already indicates the AP MLD which transmits the Action frame 700 by the source address (e.g., nontransmitted BSSID), the multilink element does not need to indicate the AP MLD of the AP affiliated with the nontransmitted BSSID AP.

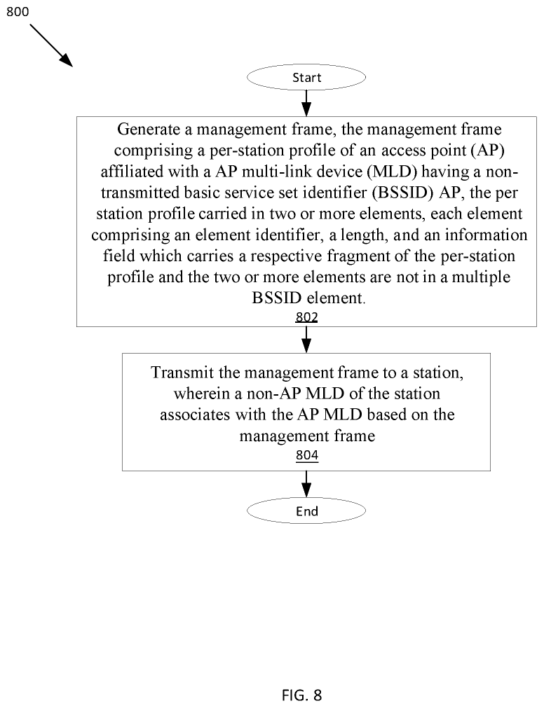

FIG. 8 depicts a flow chart 800 of functions 802-804 associated with generating and transmitting a per-station profile from an AP of an AP MLD to a station of a non-AP MLD in accordance with an embodiment.

At step 802, a management frame is generated which comprises a per-station profile of an access point (AP) affiliated with an AP MLD having a non-transmitted basic service set identifier (BSSID) AP, the per-station profile carried in two or more elements. The multiple BSSID element does not carry the element to reduce complexity of fragmentation of the per-station profile in the management frame. In one example, the element is a per-station profile element as described herein and in another example the element is in a multilink element as described herein. At step 804, the frame is transmitted. The frame may be a Multilink Probe Response transmitted by a transmitted BSSID AP with the per-station profile element or an Action frame transmitted by a non-transmitted BSSID AP with the multilink element. The non-AP MLD with the station may associate with the AP MLD of the non-transmitted BSSID AP based on the received per-station profile.

In an embodiment, a method is disclosed. The method comprises: generating a management frame, the management frame comprising a per-station profile of an access point (AP) affiliated with a AP multilink device (MLD) having a non-transmitted basic service set identifier (BSSID) AP, the per-station profile carried in two or more elements, each element comprising an element identifier, a length, and an information field which carries a respective fragment of the per-station profile and the two or more elements are not in a multiple BSSID element; and transmitting the management frame to a station, wherein a non-AP MLD of the station associates with the AP MLD based on the management frame. In an example, at least one of the two or more elements is a fragment element and the element identifier field, the length field, and the information field of the fragment element indicates a fragment identifier, a length of one of the fragments of the per-station profile, and the one fragment respectively. In an example, respective fragments of the per-station profile are carried in the two or more elements when a length of the per-station profile is greater than a maximum length of the information field. In an example, the per-station profile defines capabilities, parameters, and operational data of the AP affiliated with the nontransmitted BSSID AP of the AP MLD. In an example, the non-transmitted BSSID AP does not transmit a beacon frame. In an example, the two or more elements are subelements of a multilink element wherein a fragment is in a subelement of the multilink element. In an example, the management frame is an Action frame transmitted by the nontransmitted BSSID AP in response to a Probe Request received by the nontransmitted BSSID AP. In an example, the two or more elements includes a per-station profile element, and wherein generating the management frame comprises generating the management frame which comprises the per-station profile element, the per-station profile element comprises a fragment for only the AP of the AP MLD, the per-station profile element not in a multilink element. In an example, the management frame is a probe response frame transmitted by a transmitted BSSID AP in response to a probe request received by the transmitted BSSID AP. In an example, the per-station element further comprises an indication of the AP MLD.

In another embodiment, a system is disclosed. The system comprises processing circuitry arranged to: generate a management frame, the management frame comprising a per-station profile of an access point (AP) affiliated with a AP multilink device (MLD) having a non-transmitted basic service set identifier (BSSID) AP, the per-station profile carried in two or more elements, each element comprising an element identifier, a length, and an information field which carries a respective fragment of the per-station profile and the two or more elements are not in a multiple BSSID element; and transmit the management frame to a station, wherein a non-AP MLD of the station associates with the AP MLD based on the management frame. In an example, at least one of the two or more elements is a fragment element and the element identifier field, the length field, and the information field of the fragment element indicates a fragment identifier, a length of one of the fragments of the per-station profile, and the one fragment respectively. In an example, respective fragments of the per-station profile are carried in the two or more elements when the per-station profile of the per-station profile element is greater than a maximum length of the information field. In an example, the per-station profile defines capabilities, parameters, and operational data of the AP affiliated with the nontransmitted BSSID AP in the AP MLD. In an example, the non-transmitted BSSID AP does not transmit a beacon frame. In an example, the two or more elements are subelements of a multilink element wherein a fragment is in a subelement of the multilink element. In an example, the management frame is an Action frame transmitted by the nontransmitted BSSID AP in response to a probe request received by the nontransmitted BSSID AP. In an example, the two or more elements includes a per-station profile element, and wherein generating the management frame comprises generating the management frame which comprises the per-station profile element, the per-station profile element comprises a fragment for only the AP of the AP MLD, the per-station profile element not in a multilink element. In an example, the management frame is a probe response frame transmitted by a transmitted BSSID AP in response to a probe request received by the transmitted BSSID AP. In an example, the per-station element further comprises an indication of the AP MLD.

A few implementations have been described in detail above, and various modifications are possible. The disclosed subject matter, including the functional operations described in this specification and the processing circuit, can be implemented in electronic circuitry, computer hardware, firmware, software, or in combinations of them, such as the structural means disclosed in this specification and structural equivalents thereof: including potentially a program operable to cause one or more data processing apparatus such as a processor to perform the operations described (such as program code encoded in a non-transitory computer-readable medium, which can be a memory device, a storage device, a machine-readable storage substrate, or other physical, machine readable medium, or a combination of one or more of them).

While this specification contains many specifics, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

Other implementations fall within the scope of the following claims.

What is claimed is:

1. A method comprising:
generating a management frame, the management frame comprising a per-station profile of an access point (AP) affiliated with a AP multilink device (MLD) having a non-transmitted basic service set identifier (BSSID) AP, the per-station profile carried in two or more elements, each element comprising an element identifier, a length, and an information field which carries a respective fragment of the per-station profile and the two or more elements are not in a multiple BSSID element; and
transmitting the management frame to a station, wherein a non-AP MLD of the station associates with the AP MLD based on the management frame.

2. The method of claim 1, wherein at least one of the two or more elements is a fragment element and the element identifier field, the length field, and the information field of the fragment element indicates a fragment identifier, a length of one of the fragments of the per-station profile, and the one fragment respectively.

3. The method of claim 1, wherein respective fragments of the per-station profile are carried in the two or more elements when a length of the per-station profile is greater than a maximum length of the information field.

4. The method of claim 1, wherein the per-station profile defines capabilities, parameters, and operational data of the AP affiliated with the same AP MLD as the nontransmitted BSSID AP.

5. The method of claim 1, wherein the non-transmitted BSSID AP does not transmit a beacon frame.

6. The method of claim 1, wherein the two or more elements are subelements of a multilink element wherein a fragment is in a subelement of the multilink element.

7. The method of claim 6, wherein the management frame is an Action frame transmitted by the nontransmitted BSSID AP in response to a multilink probe request received by the nontransmitted BSSID AP.

8. The method of claim 1, wherein the two or more elements includes a per-station profile element, and wherein generating the management frame comprises generating the management frame which comprises the per-station profile element, the per-station profile element comprises a fragment for only the AP of the AP MLD, the per-station profile element not in a multilink element.

9. The method of claim 8, wherein the management frame is a probe response frame transmitted by a transmitted BSSID AP in response to a probe request received by the transmitted BSSID AP.

10. The method of claim 8, wherein the per-station element further comprises an indication of the AP MLD.

11. A system comprising:
processing circuitry arranged to:
generate a management frame, the management frame comprising a per-station profile of an access point (AP) affiliated with a AP multilink device (MLD) having a non-transmitted basic service set identifier (BSSID) AP, the per-station profile carried in two or more elements, each element comprising an element identifier, a length, and an information field which carries a respective fragment of the per-station profile and the two or more elements are not in a multiple BSSID element; and
transmit the management frame to a station, wherein a non-AP MLD of the station associates with the AP MLD based on the management frame.

12. The system of claim 11, wherein at least one of the two or more elements is a fragment element and the element identifier field, the length field, and the information field of the fragment element indicates a fragment identifier, a length of one of the fragments of the per-station profile, and the one fragment respectively.

13. The system of claim 11, wherein respective fragments of the per-station profile are carried in the two or more elements when the per-station profile of the per-station profile element is greater than a maximum length of the information field.

14. The system of claim 11, wherein the per-station profile defines capabilities, parameters, and operational data of the AP affiliated with the same AP MLD as the nontransmitted BSSID AP.

15. The system of claim 11, wherein the non-transmitted BSSID AP does not transmit a beacon frame.

16. The system of claim 11, wherein the two or more elements are subelements of a multilink element wherein a fragment is in a subelement of the multilink element.

17. The system of claim 16, wherein the management frame is an Action frame transmitted by the nontransmitted BSSID AP in response to a multilink probe request received by the nontransmitted BSSID AP.

18. The system of claim 11, wherein the two or more elements includes a per-station profile element, and wherein generating the management frame comprises generating the management frame which comprises the per-station profile element, the per-station profile element comprises a fragment for only the AP of the AP MLD, the per-station profile element not in a multilink element.

19. The system of claim 18, wherein the management frame is a probe response frame transmitted by a transmitted BSSID AP in response to a probe request received by the transmitted BSSID AP.

20. The system of claim 18, wherein the per-station element further comprises an indication of the AP MLD.
